(19) United States
(12) Patent Application Publication
(10) Pub. No.: US 2022/0398462 A1
(43) Pub. Date: Dec. 15, 2022

(54) AUTOMATED FINE-TUNING AND DEPLOYMENT OF PRE-TRAINED DEEP LEARNING MODELS

(71) Applicant: MICROSOFT TECHNOLOGY LICENSING, LLC., REDMOND, WA (US)

(72) Inventors: COLIN BRUCE CLEMENT, SEATTLE, WA (US); SHAO KUN DENG, BELLEVUE, WA (US); DAWN DRAIN, BELLEVUE, WA (US); NEELAKANTAN SUNDARESAN, BELLEVUE, WA (US); ALEXEY SVYATKOVSKIY, BELLEVUE, WA (US); YIDING TIAN, SHANGHAI (CN); MICHELE TUFANO, BELLEVUE, WA (US); PAUL AN-CHIEH WANG, SURREY (CA); CHEN WU, BEIJING (CN); DONGJIANG YOU, KIRKLAND, WA (US)

(21) Appl. No.: 17/347,205

(22) Filed: Jun. 14, 2021

(51) Int. Cl. G06N 3/08; G06N 3/04

(52) U.S. Cl. CPC G06N 3/088; G06N 3/0454

(57) ABSTRACT

A cloud platform includes several web services that facilitate the automated tuning and deployment of pre-trained deep learning models configured for software engineering tasks. The automated tuning and deployment allow a developer to fine-tune a pre-existing model without having access to the parameters of the pre-existing and the fine-tuned model in a manner that does not require user management input. The cloud platform provides a set of files for each pre-trained models used to automatically build a fine-tuning infrastructure to fine-tune a model and a deployment infrastructure that deploys the fine-tuned model without requiring user input.

### BACKGROUND

Deep learning models are used often to solve a variety of problems. Deep learning models employ neural networks that are trained to learn, recognize patterns and make predictions. One drawback of these models is the extensive amount of time and resources that is needed to train a model. A model may require a training dataset of real-world data consisting of several million data samples which are mined from various sources. The training itself may take days to weeks of computing time and resources. Neural networks are trained iteratively, making multiple passes over the training dataset before converging to a minimum. The training is iterative and the entire training dataset is passed through the neural network in multiple iterations to find the hyperparameters (e.g., model architecture, vocabulary encoding procedures, training objective, data normalization) that meet a target objective.

In order to reduce the training time and cost in developing a deep learning model, transfer learning is often utilized. In transfer learning, a pre-trained model is used as a starting point for a related task. The pre-trained model is then trained or fine-tuned with a supervised dataset of the related task. The parameters of the pre-trained model are reused thereby saving a significant amount of training time and resource consumption. However, a considerable amount of expertise is needed to properly fine-tune a pre-trained model for a specific task. This expertise creates a barrier for individuals not having this expertise to reuse the pre-trained models.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A cloud platform provides web services to enable the automated fine-tuning, deployment and execution of pre-trained deep learning models customized for software engineering tasks without user configuration input. The cloud platform builds a fine-tuning infrastructure to fine-tune a pre-trained deep learning model, a deployment infrastructure that deploys the fine-tuned deep learning model, and a model execution service that runs the model with the user's inference dataset, without requiring the user (e.g., developer, customer, client, etc.) to specify the infrastructure configurations.

The cloud platform provides the model files, tokenizers, scripts and related environment definitions and packages to fine-tune a pre-train model, deploy the model on the virtual machines of the cloud platform, and to execute the model on the user's inference dataset without allowing access to the model's internal data structures. In this manner, the cloud platform is able to provide the automatic construction of the tuning, deployment, and execution infrastructures for those users having limited machine learning expertise without disclosing the internal parameters of the models to the users.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary system for the automated tuning and automated deployment of pre-trained deep learning models configured for software engineering tasks.

FIG. 2 is a schematic diagram illustrating an exemplary catalog of the pre-trained deep learning models.

FIG. 3 is a schematic diagram illustrating an exemplary architecture of an encoder neural transformer model with attention and an exemplary architecture of a decoder neural transformer model with attention.

FIG. 4 is a schematic diagram illustrating an exemplary architecture of an encoder-decoder neural transformer model with attention.

FIG. 5 is a flow diagram illustrating an exemplary method of the automated fine-tuning and deployment system.

FIG. 6 is a schematic diagram illustrating an exemplary configuration of the components used in automated fine-tuning.

FIG. 7 is a flow diagram illustrating an exemplary method of the pre-processing stage of the automated fine-tuning.

FIG. 8 is a flow diagram illustrating an exemplary method of the fine-tuning stage of the automated fine-tuning.

FIG. 9 is a schematic diagram illustrating an exemplary configuration of the components used in automated deployment.

FIG. 10 is a flow diagram illustrating an exemplary method of automated deployment.

FIG. 11 is a flow diagram illustrating an exemplary method of automated execution.

FIG. 12 is a block diagram illustrating an exemplary operating environment.

### DETAILED DESCRIPTION

Overview

A cloud platform is disclosed that provides web services to enable the automated tuning, deployment, and execution of pre-trained deep learning models customized for software engineering tasks. The cloud platform offers several deep learning models, having been trained on large unsupervised datasets of natural language text and source code, for use by users (e.g., developers, customers, clients, researchers, etc.), to fine-tune for a particular downstream related task. The reuse of the pre-trained models with developed weights and biases for source code is a good starting point to develop different models for various software engineering tasks faster and with less computational cost and resources. The cloud platform builds a fine-tuning infrastructure to fine-tune a pre-trained deep learning model, a deployment infrastructure that deploys the fine-tuned deep learning model, and a model endpoint to facilitate execution of the model, without requiring the developer to specify the infrastructure configurations.

Fine-tuning refers to a transfer learning technique that copies the internal data learned by the pre-trained model which is updated for a related task. Fine-tuning differs from feature extraction which only updates the final layer weights. Fine-tuning requires a user to find a pre-trained model having a suitable architecture, domain-knowledge, and hyperparameters for its intended downstream task. The pre-trained deep learning models offered on the cloud platform are configured and trained for specific software engineering tasks that can easily be fine-tuned for a related task. In this manner, the cloud platform is able to provide the automatic construction of the tuning and deployment infrastructures for these tasks which is beneficial for those users having limited machine learning expertise.

The cloud platform provides automated tuning, deployment, and execution of the pre-trained deep learning models. As the cost of generating the pre-trained models becomes more expensive, there is an increased reluctance to share the models publicly which negatively impacts the advancement of machine learning. In order to address this concern and to allow sharing of the models, automated fine-tuning restricts access to certain internal data of the pre-trained models and the fine-tuned models while allowing the models to be used by others with access only to the results generated by the fine-tuned model.

Automated fine-tuning refers to a mechanism that allows a developer to fine-tune a pre-existing model without having access to the internal data or parameters of the pre-existing and fine-tuned models, such as the weights, biases, and embeddings (e.g., subtoken and positional embeddings), learned by the models. Automated deployment refers to a mechanism that allows a developer to deploy a model on the cloud platform. Automated execution refers to a mechanism that allows the developer to use the model on a custom inference dataset.

In addition, the cloud platform configures the infrastructure required to perform the automated tuning, deployment, and execution without user configuration input. The user provides the fine-tuning dataset that is used to fine-tune a selected pre-trained model and the inference data used in the execution of the fine-tuned model without specifying the configuration of the resources needed to perform the fine-tuning, deployment, and execution. The configuration includes the number of virtual machines, the size of the virtual machines (number of CPUs, amount of memory, amount of disk storage disk, number of GPUs), the operating system of the virtual machines, the pre-installed tools and packages on the virtual machines, the virtual machine scaling rules (e.g. add or remove machines depending on a threshold of CPU usage).

In addition, the fine-tuning infrastructure includes the fine-tuning script, the tokenizer and input embeddings used to transform the user's tuning dataset into the format required by the model, and the automatic configuration of the virtual machines needed to perform the fine-tuning tasks with all associated data (e.g., environment files, docker images, packages etc.). The deployment infrastructure includes a deployment script, the model files of the fine-tuned model, a model endpoint, and the automatic configuration of the virtual machines needed to operate the model. The execution infrastructure includes an inference script, a tokenizer, and the associated data to execute the model with the user's inference dataset.

Attention now turns to a more detailed description of the system, methods, and devices of the cloud platform.

System

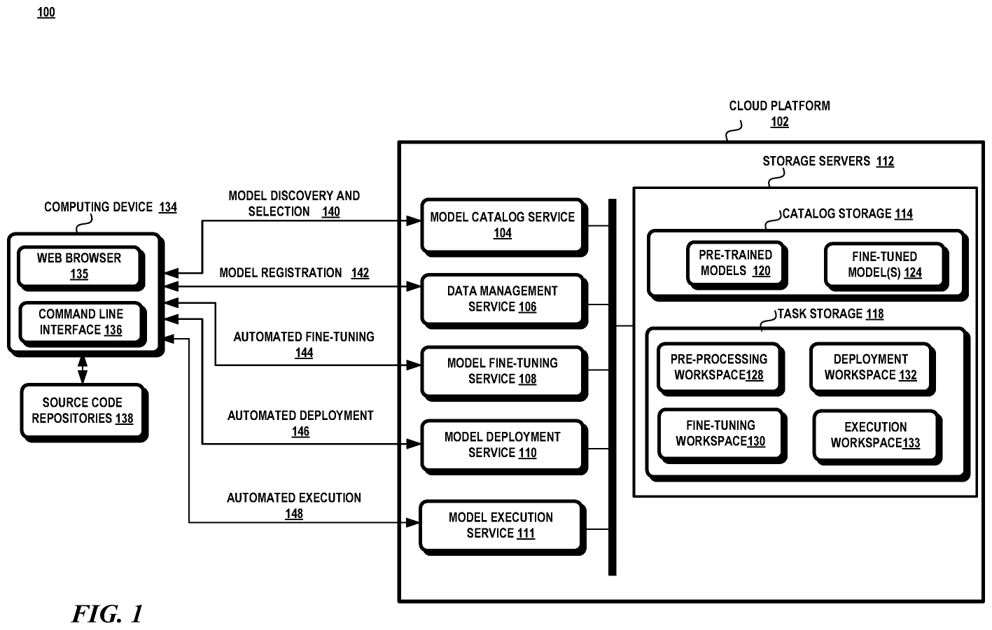

FIG. 1 illustrates an exemplary system 100 having a cloud platform 102 offering web services to fine-tune and deploy pre-trained deep learning models for software engineering tasks without direct active management by a user. The cloud platform 102 includes several web services 104, 106, 108, 110, and storage servers 112. The web services include a model catalog service 104, a data management service 106, a model fine-tuning service 108, a model deployment service 110, and a model execution service 111. The model catalog service 104 lists the models offered by the cloud platform and their related properties. The data management service 106 receives registration requests for usage of a pre-trained model. The model fine-tuning service 108 generates the infrastructure needed to perform the fine-tuning task and executes the requested fine-tuning on a selected pre-trained model. The model deployment service 110 generates the infrastructure needed to deploy the model and provides an endpoint for the user to run the fine-tuned model. The model execution service 111 facilitates runs the deployed model with a custom inference dataset.

The storage servers 112 include a catalog storage 114, the user's storage accounts 116, and task storage 118. The catalog storage 114 includes the various configurations of the pre-trained models 120 and the fine-tuned models 124, along with the files need to fine-tune and deploy these models. A user's storage account 116 may include a fine-tuning dataset 122 and the user's registration data 126. The task storage 118 contains separate and isolated storage areas that are used by a respective service. The pre-processing workspace 128 is used by a pre-processing engine, the fine-tuning workspace 130 is used by a fine-tuning engine, and the deployment workspace 132 is used by a deployment engine.

A user interacts with the cloud platform 102 through a computing device 134. The computing device 134 includes a web browser 135 and a command line interface 136. The computing device 134 interacts with one or more source code repositories 138 which may be internal or external to the computing device 134.

The user interacts with the services of the cloud platform through Representational State Transfer (REST) Application Programming Interfaces (APIs). The REST APIs are service endpoints that support a set of HyperText Transfer Protocol (HTTP) operations or methods to create, retrieve, update, delete or access resources of a web service. In one aspect, the user interacts with the cloud platform through a command line interface, such as cURL. cURL is a command line interface that transmits data using the HTTP protocol from a web browser.

The cloud platform provides a set of REST APIs that are used to perform various operations. There is a set of REST APIs for model discovery and selection 140, a set of REST APIs for model registration 142, a set of REST APIs for automated fine-tuning 144, a set of REST APIs for automated deployment 146, and a set of REST APIs for automated execution 148.

Although the system 100 as shown in FIG. 1 has a limited number of elements in a certain topology, it may be appreciated that the system 100 may include more or less elements in alternate topologies as desired for a given implementation.

Attention now turns to a description of the pre-trained models.

Pre-Trained Models

Machine learning pertains to the use and development of computer systems that are able to learn and adapt without following explicit instructions, by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping. Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks.

In one aspect, the cloud platform offers various configurations of neural transformer models with attention. Neural transformers models are one type of deep learning that utilizes an attention mechanism. Attention directs the neural network to focus on a subset of features or tokens in an input sequence thereby learning different representations from the different positions of the tokens in an input sequence. The attention mechanism provides the model with a better capability to learn the task at hand thereby generating more accurate predictions of the candidate method bodies. It should be noted that the term neural transformer model with attention and neural transformer model are used interchangeably.

The cloud platform offers various configurations of neural transformer models, such a model with encoder-only transformer blocks, decoder-only transformer blocks, or with encoder-decoder blocks. Each model configuration is trained with a large unsupervised corpus of source code and/or natural language code summaries and the weights, biases and embeddings learned in the unsupervised training may be fine-tuned for a particular software engineering task. A natural language code summary is natural language text that describes a particular portion of source code. The natural language text may be code documentation found in a source code file and/or descriptions of a method or other program elements that can be found in blogs, manuals, or websites.

A software engineering task is an automated activity used to create, develop, maintain, and/or test source code. Source code understanding is needed in a variety of software engineering tasks, such as, without limitation, method completion, documentation/code generation, bug classification, bug patching, code search, and line completion. A software engineering task utilizes the architecture of a particular neural transformer model that aligns best with the task.

The software engineering tasks all require an understanding of source code. Source code differs from a natural language (e.g., English) since programmers use, at times, arbitrary, complex and long names to represent a variable, function or other code elements. Source code can be learned from a large unsupervised abundant corpus of code snippets from different programming languages and/or from natural language code summaries from which a neural transformer model learns statistical properties of the source code, such as syntactic rules of the programming languages, as well as semantic information from co-occurrence of specific variable and method names.

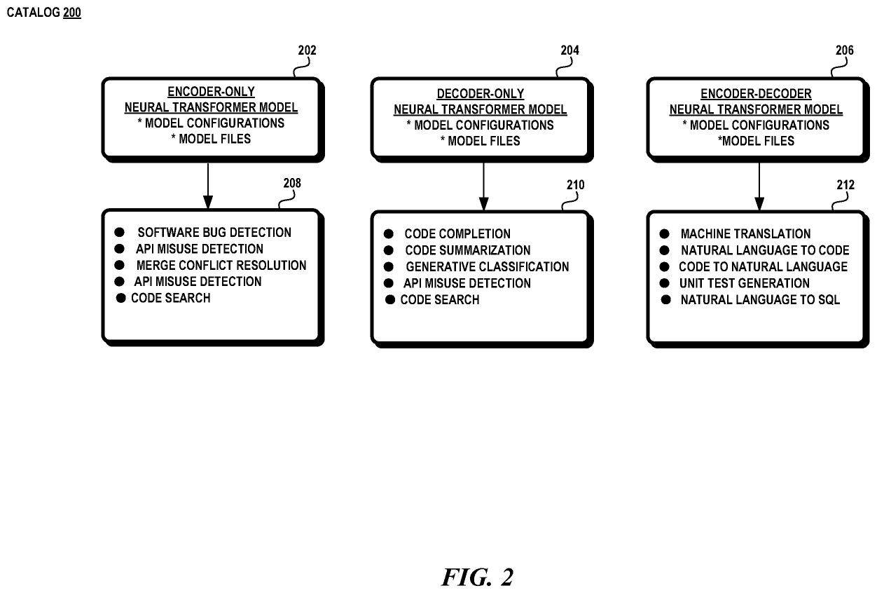

Turning to FIG. 2, there is shown an exemplary catalog of pre-trained neural transformer models 200. Different software engineering tasks align with a particular neural transformer architecture which allows for the transfer of the weights and biases from the trained model for discriminative fine tuning on specific downstream tasks.

An encoder-only neural transformer model with attention 202 is trained on a large unsupervised training dataset of source code and natural language source code summaries. The encoder-only neural transformer model is then fine-tuned by a fine-tuning component with a particular supervised training dataset for a particular downstream task to produce a corresponding model. Examples of software engineering tasks that are suited for an encoder-only neural transformer model include source code bug identification, API misuse identification, issues de-duplication, merge conflict resolution and code search 208.

Source code bug identification identifies a source code snippet (e.g., method, class, etc.) as having a particular type of source code bug. Merge conflict resolution indicates whether changes across the two branches in a version control system can be merged or having a conflict. Code search identifies source code snippets that are similar to a target source code snippet. API misuse identification identifies when a source code snippet is requesting an API in a manner that may be syntactically correct but not its intended use. Issues de-duplication identifies cases where multiple issues on a cloud source code issue-tracking platform, such as GitHub or BitBucket, are referring to the same underlying problem.

An encoder neural transformer with attention is better suited for classification tasks due to the type of attention used in the encoder. An encoder uses bi-directional attention which enables the encoder to learn the relationships of the tokens/subtokens in an input sequence both before and after their occurrence. Classifiers are trained to interpret a model's internal representation into a class label. Since bi-directional attention allows the model's internal representation to depend on all other tokens, and not just the previous tokens, bi-directional attention leads to superior classification performance.

The decoder-only neural transformer model 204 is an auto-regressive model that produces an output one element at a time based on the outputs of previous time steps. Code completion is best suited for a decoder neural transformer model since it is an auto-regressive task that predicts an ordered sequence of tokens where the order depends on the preceding tokens in the sequence. The decoder uses a masked self-head attention which is best suited for auto-regressive tasks since it is explicitly trained to generate auto-regressively. This type of neural transformer model is best suited for code completion tasks, code summarization tasks, and generative classification 210. Code completion predicts the rest of a partially-formed method invocation, a partially-formed line of source code, or a partially-formed method. Code summarization generates a short and readable natural language description from a snippet of source code. Generative classification determines the correct type and language of output to generate and generates natural language and code snippets, in a single pass.

An encoder-decoder neural transformer model with attention 206 is suited for machine translation tasks. A machine translation model learns a function that translates an input sequence into an output sequence (i.e., sequence-to-sequence translation). For software engineering tasks, the input sequence is a particular source code construct and the output sequence is another source code construct or natural language text string. Examples of such machine translation tasks include the translation of a method signature into a documentation string for the method signature, translate a method signature into a corresponding method body, translate a documentation string for a method into a method body, translate a method body into a method signature, translate a documentation string for a method into a method signature, translate a buggy source code snippet into a repair patch for the buggy source code, translate a source code method into a unit test case for the method, translate natural language text into SQL, and the like 212.

The cloud platform offers each type of neural transformer model in different configurations. A neural transformer model has multiple blocks and layers within each block so that more detailed relationships within the data are learned as well as how the features interact with each other on a non-linear level. The model architecture, training procedure, data normalization and vocabulary encoding procedures are hyperparameters that are tailored to meet a particular objective. The parameters of the model are the values of the model, such as the weights (e.g., Q, K, V), biases, subtoken and positional embeddings. The hyperparameters influence the way the model is built and how the parameters are learned.

Each model configuration lists the hyperparameters of the model. In one aspect, the hyperparameters may include the following: (1) the dimensions of the subtoken and position embedding layers; (2) the configuration of the neural transformer model with the number of encoder and/or decoder blocks; (3) the pre-training procedure: (e.g., denoising auto-encoder, with a cross-entropy loss optimization objective; the sequence length of 1024 symbols; a mini-batch size of 8; the gradient accumulation steps for each weight update is 8; the Adam stochastic optimization procedure is used to train the feed forward neural network; and the learning rate is 0.0001); (4) the data normalization procedure: (e.g., normalize all string and numerical literals, keeping the ten most frequent); (5) the vocabulary encoding procedure: (e.g., byte-level byte-pair encoding, preserve the ten most frequent string and numerical literals encoding them as a single token during byte-level byte-pair encoding procedure and introduce special control flow tokens to denote end-of-line, end-of-file, end-of-method, dedent, and indent symbols); (6) type of input and output (e.g., natural language, source code programming language, etc.); and (7) input and output domain (e.g., natural languages, source code programming languages, etc.).

For each model configuration, there are model files used to facilitate the automated tuning, deployment, and execution of a particular model configuration without the user's input. The model files are not accessible by the user, not disclosed to the user, and kept isolated from the user. The model files may include additional files to facilitate the use of the model such as, a pre-processing script, a tokenizer file, input embedding file, a fine-tuning script, a deployment script, an inference script and an environment definition (e.g., coda environment file).

The pre-processing script is used to prepare the user's fine-tuning dataset for tuning the model. The pre-processing may include removing comments from source code files, removing indent characters, and/or generating input sequences of tokens. The pre-processing script may use a tokenizer to turn the user's fine-tuning dataset into a sequence of tokens having the same token base used by the pre-trained deep learning model. The tokenizer transforms source code and natural language text into a sequence of tokens which are encoded into an input embedding. The input embedding was learned by the pre-trained model.

The fine-tuning script contains the instructions that perform the fine-tuning by applying the input sequences of embeddings to the pre-trained model. The fine-tuning updates the previously-learned embeddings for the target downstream task producing task-specific embeddings. In the case of fine-tuning an encoder neural transformer for a specific classification task, the fine-tuning script replaces the output layer of the pre-trained model with a classification layer specific for the task-specific embeddings while reusing all encoder blocks.

The deployment script contains the instructions to deploy the fine-tuned model on one or more virtual machines. The inference script contains the instructions used to run the deployed model with the user's inference dataset. An environment definition file includes source code language specific packages that are needed to execute the model. In one aspect, the environment definition file includes a conda environment file which includes a directory that includes packages needed to be installed to execute the fine-tuned model. Examples of such packages include Pip, PyTorch, TensorFlow, pandas, NumPy, sk-learn, Keras, matplotlib, etc.

Attention now turns to a further description of the various neural transformer architectures.

Neural Transformer Architectures

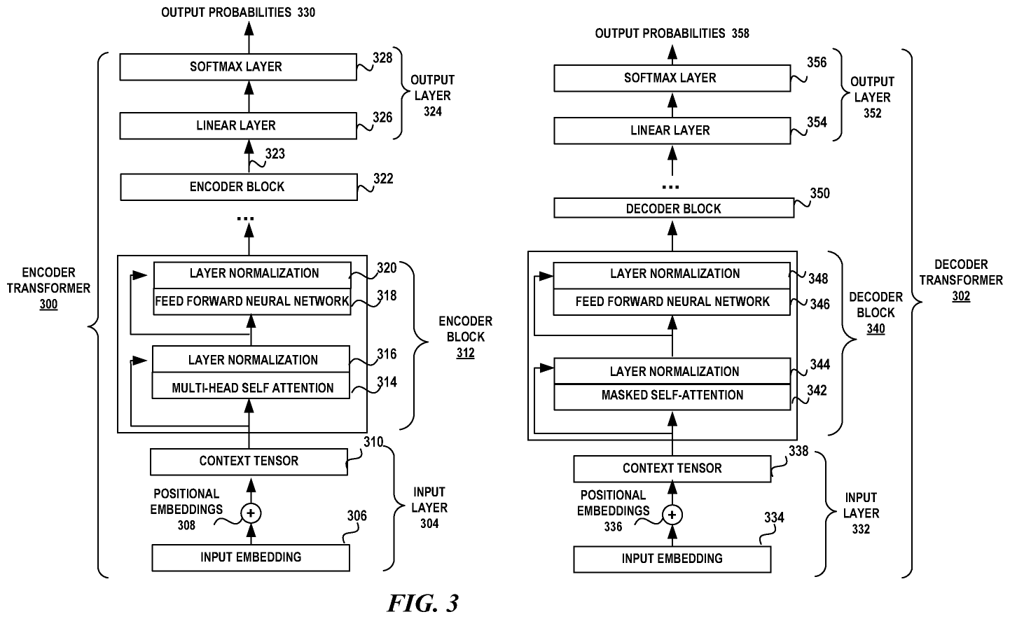

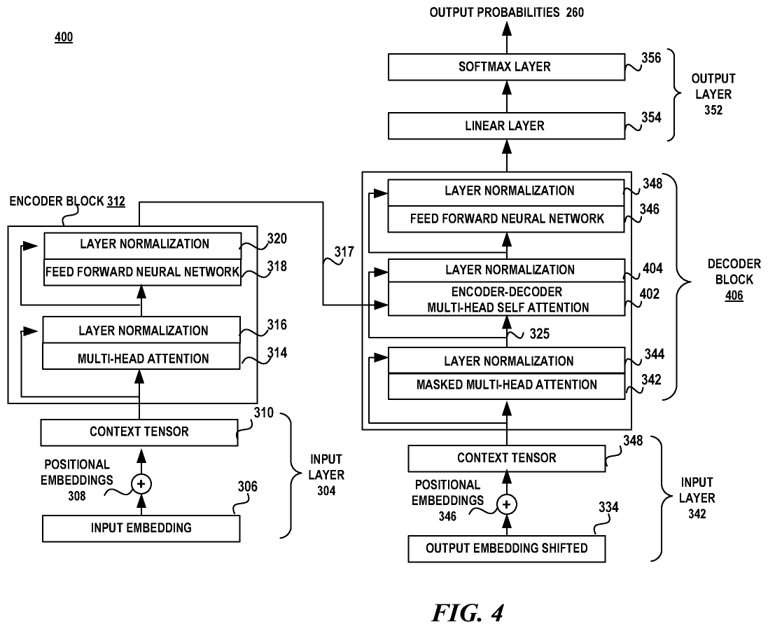

There are different configurations for a neural transformer. FIG. 3 shows an exemplary configuration of an encoder neural transformer and a decoder neural transformer. FIG. 4 illustrates an exemplary configuration of an encoder-decoder neural transformer.

Referring to FIG. 3, the encoder neural transformer 300 includes an input layer 304, one or more encoder blocks 312, and an output layer 324. The input layer 304 includes input embeddings of an input sequence of the fine-tuning or inference dataset 306 and positional embeddings 308 that represents an order of the tokens/subtokens in an input sequence. The input embeddings 306 and the positional embeddings 308 are combined to form a context tensor 310.

An encoder block 312 consists of two layers. The first layer includes a multi-head self-attention component 314 followed by layer normalization component 316. The second layer includes a feed-forward neural network 318 followed by a layer normalization component 320. The context tensor 310 is input into the multi-head self-attention layer 314 of the encoder block 312 with a residual connection to layer normalization 316. The output of the layer normalization 316 is input to the feed forward neural network 318 with another residual connection to layer normalization 320. The output of each encoder block is a set of hidden representations 323. The set of hidden representations 323 are then sent through additional encoder blocks, if multiple encoder blocks exist.

Attention is used to decide which parts of the input sequence are important for each token/subtoken, especially when decoding long sequences since the encoder is limited to encoding a fixed-size vector. Attention mechanisms gather information about the relevant context of a given token/subtoken and then encode that context into a vector which represents the token/subtoken. It is used to identity the relationships between tokens in the long sequence while ignoring other subtokens that do not have much bearing on a given prediction.

The multi-head self-attention component 314 takes a context tensor 310 and weighs the relevance of each token/subtoken represented in the context tensor to each other by generating attention weights for each token/subtoken in the input embedding 306. In one aspect, the attention function is scaled dot-product attention which is described mathematically as follows:

$$Attention ( Q , K , V ) = softmax ( \frac{{QK}^{T}}{\sqrt{{d}_{k}}} ) V ,$$

where the input consists of queries Q and keys K of dimension dₖ, and values V of dimension dᵥ. Q is a matrix that contains the query or vector representation of one token/subtoken in a sequence, K is the vector representations of all tokens/subtokens in the sequence, and V is the vector representations of all the tokens/subtokens in the sequence.

The queries, keys and values are linearly projected h times in parallel with dᵥ output values which are concatenated to a final value:

MultiHead(Q,K,V)=Concat(head₁, . . . ,headₕ)W^{o},

where headᵢ=Attention(QWᵢ^{Q},KWᵢ^{K},VWᵢ^{V}),

with parameter matrices Wᵢ^{Q}ϵ [symbol] ^{d}^{_{model}}^{×d}^{ₖ},Wᵢ^{K}ϵ [symbol] ^{d}^{_{model}}^{×d}^{ₖ},Wᵢ^{V}ϵ [symbol] ^{d}^{_{model}}^{×d}^{ₖ}, and W^{O}ϵ [symbol] ^{hd}^{ᵥ}^{×d}^{_{model}}.

In order to reduce the training time of the neural transformer, layer normalization is used between the layers. The layer normalization component normalizes the inputs across the features. The mean and standard deviation is computed across the feature dimensions. There is a first layer normalization 316 that precedes the feed forward neural network 318 and a second layer normalization 320 that follows the feed forward neural network 318. The feed-forward neural network 318 processes each output encoding separately. The output of the top encoder block 322 is a set of attention vectors K and V 223 that represent the last hidden layer.

The output layer 324 consists of a linear layer 326 and a softmax layer 328. The linear layer 326 is a fully-connected neural network that projects the raw scores output by the last layer of the neural network into a logits vector. The softmax layer 328 applies the softmax function to the logits vector to compute a vector that represents the probability distribution of a list of potential outcomes 330.

The decoder neural transformer model 302 includes an input layer 332, one or more decoder blocks 340, and an output layer 352. A decoder block 340 consists of two layers. The first layer includes a masked self-attention component 342 followed by a layer normalization component 344. The input to the masked multi-head self-attention component 342 has a residual connection to layer normalization 344. The output of layer normalization 344 is input into the feed forward neural network 346 with a residual connection to layer normalization component 348. The output of the feed forward neural network is input into layer normalization component 348.

Each token/subtoken flows through all the decoder blocks along its own path. The masked self-attention component 342 allows the neural network 346 to focus on certain features or inputs. The inputs to the decoder block 334 are added with the positional embeddings 336 forming context tensor 338. The decoder block 340 predicts each token/subtoken tᵢ in the target language one-by-one at each time step conditioned on all previously-generated target tokens/subtokens t₁, . . . tᵢ₋₁.

The masked self-attention component 342 masks the output embeddings from future time steps. The feed-forward neural network 346 processes each output embedding separately. A layer normalization component 344, 348 is used between the layers in order to normalize the inputs across the features.

The linear layer 354 projects the vector produced by the stack of decoders into a logits vector. The softmax layer 356 then turns the scores of the logits vector into probabilities for each token in the vocabulary 358 which are positive and normalized.

FIG. 4 illustrates an exemplary configuration of an encoder-decoder neural transformer with attention. The model 400 incorporates one or more encoder blocks 312 as described above and one or more decoder blocks. In this particular transformer configuration, the encoder block 312 does not have an output layer. The output of the top encoder block is a set of attention vectors K and V 317 which is used by the encoder-decoder multi-head attention layer 402 of the decoder block 406. The input layer 304 of the encoder block 312 operates as described above.

The decoder block 406 contains a masked multi-head attention component 342, an encoder-decoder multi-head self-attention component 402, and feed forward neural network 346. The output of masked multi-head attention component 342 is input into layer normalization 344, the output of the encoder-decoder multi-head self-attention component 402 is input into layer normalization 404, and the output of feed forward neural network 346 is input into layer normalization 348. The output of layer normalization 344 has a residual connection to layer normalization 404, the output of layer normalization 404 has a residual connection to layer normalization 348, and the input to the masked multi-head attention 342 has a residual connection to layer normalization 344.

The masked multi-head attention component 342 receives the output embeddings of the previous timestep 334. The masked multi-head attention component 342 masks the output embeddings from future time steps. The encoder-decoder multi-head attention layer 402 receives queries from the previous decoder layer 342 and the memory keys and values 317 from the output of the encoder block 312. In this manner, the decoder block 406 can attend to every position of the input sequence.

Automated Fine-Tuning

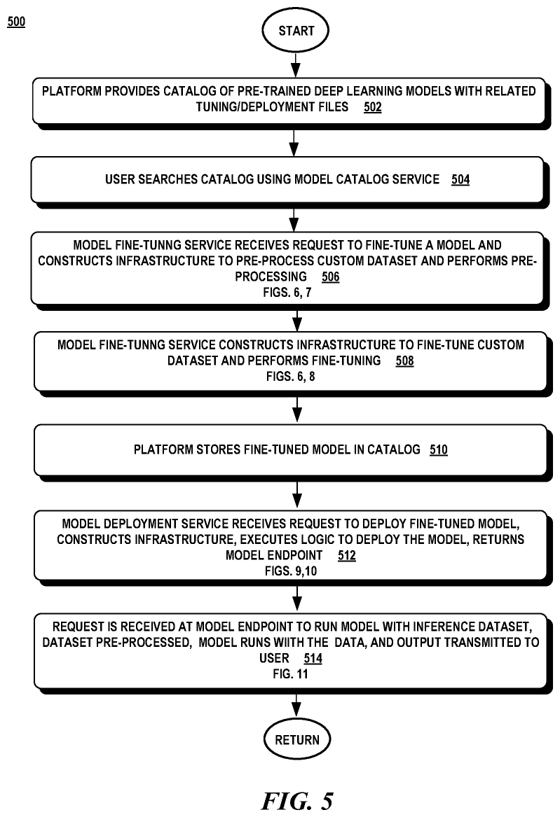

Attention now turns to description of the automated fine-tuning. Turning to FIG. 5, there is shown an exemplary method 500 for automated fine-tuning and deployment of a deep learning model of the cloud platform.

The platform offers several configurations of deep learning models for a user to tune for an intended downstream task. The intended downstream task is related to the tasks the model has been previously pre-trained for. For example, consider the software bug classification task where an encoder neural transformer model can identify whether a code snippet is likely to have a particular type of source code bug. The output of the model is a probability distribution containing a probability for each type of source code bug or class the model is trained to predict. The bug types or classes may be a null pointer reference, an immutable cast, an empty vector access, and so forth.

The bug classification model is constructed by fine-tuning the source code domain encoder neural transformer model (i.e., pre-trained encoder neural transformer model) with a supervised training dataset that includes code snippets having an identified bug type with a prefix that identifies the bug type. The fine-tune training makes minimal architectural changes to the pretrained model, reusing all layers of the pre-trained model and reconfiguring the output layer, which is a classification layer tailored for the particular classes that represent the bug types. Fine tuning is applied to all the parameters of the pre-trained model and the output layer. The fine-tuning training is not a computationally expensive task, as it only requires a few training epochs.

The output layer of the pre-trained model is replaced with a classification layer that learns a new weight matrix of dimension K×H from randomly-initialized values, where K is the number of classes in a downstream classification task and where H is the dimension of the output of last encoder block. The output layer of the pre-trained model is not used since its weight matrix is of a different size that may not contain the classes of the target classification task. Instead, the new classification layer which has the number of hidden units set to the number of classes K of the fine-tuning classification task with a softmax activation function. The predicted probability P for the j-th class given an output of last encoder block x and weight matrix W corresponding to the classification layer is as follows:

P (y=j|x)=exp (x^{T}Wⱼ+b)/[Σ_{k=1 . . . K} exp(x^{T} Wₖ+b)], where K is the number of classes, W is the weight matrix of dimension K×H, H is the dimension of x, the output of last encoder block, b is the bias value.

In the case of a source code domain decoder neural transformer model, the architecture of the pre-trained model does not need to be altered to be fine-tuned on auto-regressive software engineering tasks. The weights and biases of the pre-trained model can be used as a good starting point to train the model on fine-tuning tasks. The pre-training dataset may cover large amounts of source code files in different programming languages, natural language source code summaries, and documents containing natural language. The fine-tuning dataset may be restricted to the function-level data containing function signatures and bodies extracted from programs, buggy code sequences with an identified bug type, code sequences containing bug and corresponding fixed code.

The pre-trained encoder-decoder neural transformer model is used for machine translation. If the fine-tuning task uses the same vocabulary as the pre-trained model, then no changes to the embedding layer or encoder blocks of the encoder-decoder neural transformer model are performed. If the fine-tuning task requires a different vocabulary than the pre-training stage, then the embedding layer of the pretrained model is not transferred for finetuning and a randomly initialized embedding layer is used instead. The encoder blocks and the decoder blocks from the pre-trained encoder-decoder are transferred. The fine-tuning component uses the supervised training dataset to fine tune all the model parameters end-to-end, for a small number of epochs (i.e., 5 epochs) and validates the model.

For each of the above examples, the cloud platform provides the required scripts, data, and files to generate the infrastructure to perform the fine-tuning and deployment without having the user provide any of this type of data. The user provides the fine-tuning dataset and the inference dataset. In this manner, the user does not need to have an expertise in machine learning in order to reuse a pre-trained model.

Referring to FIG. 5, the model discovery and selection service enables a user to peruse the catalog of models and related descriptions to select a model. The model discovery and selection service provide a set of APIs to obtain this information. For example, there is a list_models API (e.g., https://deepdev.azwebsites.net/api/list_models) which returns the list of models in the catalog and a get_model API (e.g., https://deepdev.azwebsitres.net/api/get_model) that provides details of a particular model in the catalog. The details of a model may include the hyperparameters and the software engineering tasks associated with a model (Collectively, block 502).

The user is able to search the catalog by issuing a respective API call through the command line interface. For example, the user can make the following call with the command line tool cUrl, which will return all models named “gptc” that are trainable: curl -X “GET” https://deepdev.azurewebsites.net/api/models?name=gptc&trainable=True. When the user decides on a suitable pre-trained model for their intended task, the user creates a storage account in a web-enabled repository (e.g., cloud platform or other storage repository). The user then transfers their fine-tuning dataset into the user's storage account. (Collectively, block 504).

When the user decides on a model to use, the user generates a request that is sent to the data management service endpoint. The request uses the train_aml API and includes a JSON file identifying the selected model and related data. For example, the JSON file may include the following:

```
{
  “model_config”: {
    “name”: “decoder”,
    “version”: “java”,
    “owner”: “abc”,
    “version_new”: “newdecoder”,
    “storage_account_name”: “datasetcatalog”.
    “storage_account_container”: “temp”,
    “storage_account_sas”: “<sas_key>”,
    “ data_dir”: “newdata”
      }
}
```

The name tag in the model configuration schema identifies the name of the pre-trained model from the catalog. The version tag indicates the source code languages supported by the model and in this example, the model accepts the version of the model tailored for the Java programming language. The owner tag identifies the user registered with the cloud platform. The version_new tag indicates the new name of the fine-tuned model. The storage_account_name identifies the user's storage account on the cloud platform. The storage_account_container identifies the container in the storage account, which is analogous to the disk on a local computer, and the storage_account_sas is the key to the user's storage account. The data_dir tag identifies the directory inside the storage container where the data is located. (Collectively, block 506).

The request may be sent from the command line interface as follows:

curl -X PUT -H “Content-Type: application/json”-H “apiKey: wW1TfRT7NZHF5CXpvz4qWGX448OH8uRN”—data “@model.json” https://deepdev.azurewebsites.net/api/train_aml.

The “-X POST” indicates that the request will be sent using the POST method, “-H “Content-Type: application/json”” indicates that the data sent will be in the JSON format, “-H “apiKey: wW1TfRT7NZHF5CXpvz4qWGX448OH8uRN”” indicates the API key used for authentication, “-data “@model.json”” indicates that the request data will be read from the local model.json file, the content of which can found in the appendix, and “https://deepdev.azurewebsites.net/api/train_aml” is the URL where the request will be sent. (Collectively, block 506).

Upon the model fine-tuning service receiving a request to fine-tune the selected model, the service constructs the infrastructure to pre-process the user's fine-tuning dataset and performs the processing (block 508). Upon successful completion of the pre-processing, the model fine-tuning service then constructs the infrastructure to fine-tune the selected pre-trained model and performs the fine-tuning (block 510). Upon successful completion of the fine-tuning, the fine-tuned model is then stored in the catalog (block 512).

The model deployment service receives a request to deploy the selected model. In response the model deployment service constructs the infrastructure to run the fine-tuned model and executes the deployment script. Upon successful completion of the deployment, the service provides the user with an endpoint of the deployed model for the user to use to run the model with its inference dataset (Collectively, block 514).

The user is then able to use the model with the inference dataset by sending a request to the model's endpoint. An exemplary request may be made at the command line as follows:

curl -X POST “https://deepdev.azure.com:443/api/service/us80klmnad/score”—data ‘{“prompt”; “def load_all_files(directory, pattern):\n”)’-H “Content-Type: application/json”,

where “https://deepdev.azure.com:443/api/service/us80klmnad/score” is the URL of the model's endpoint,

-data ‘{“prompt”; “def load_all_files(directory, pattern):\n”)’ is the location of the inference dataset, and

-H “Content-Type: application/json” indicates that the inference dataset is read from a JSON file. (Collectively block 516).

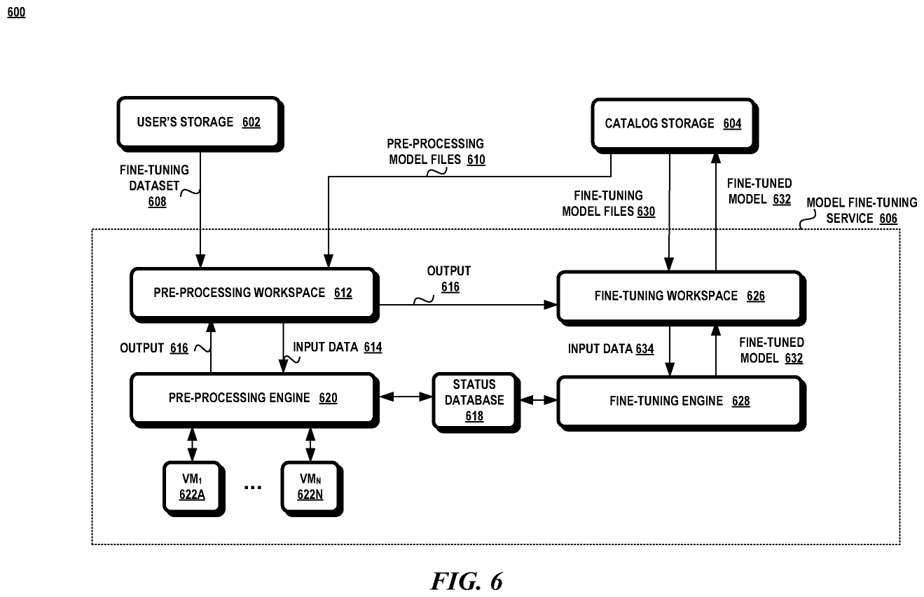

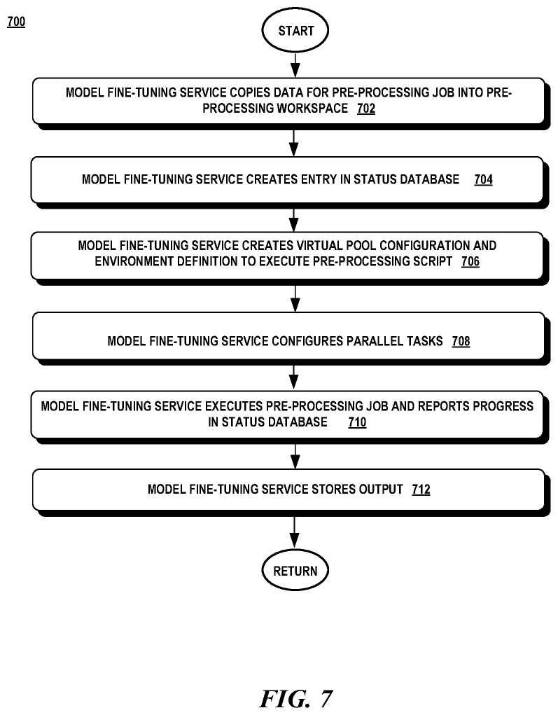

Attention now turns to FIGS. 6 and 7 which illustrate the components 600 and method 700 used to pre-process the user's fine-tuning dataset. In order to fine-tune the model with the user's tuning dataset, the user's tuning dataset may have to be processed. In some cases, the pre-processing may be to remove comments, indents or other characters from a file, and to extract input sequences of tokens in a format used by the model.

The model fine-tuning service 606 utilizes a pre-processing engine 620 to pre-process the fine-tuning dataset. The model fine-tuning service 606 copies the fine-tuning dataset 624 from its storage location 602 and the pre-processing files 610 from the catalog storage 604 to the pre-processing service's private workspace 612. The pre-processing files include a pre-processing script, the tokenizer, and the embeddings and the pre-processing conda environment definition, if applicable. The pre-processing script contains the executable instructions that perform the required processing. (Collectively, block 702).

The pre-processing engine 620 creates an entry for the pre-processing job in the status database 618. Throughout the pre-processing job, the pre-processing engine 620 generates status updates which are posted to the status database 618. A user may query the status of the pre-processing job by issuing a train_status API to the model fine-tuning service. The model fine-tuning service 606 generates a response from the most updated entry in the status database 618 for the job. (Collectively, block 704).

The pre-processing engine 620 creates a virtual machine pool configuration which contains the definitions of a docker image and the startup job that sets up the working environment. The virtual machine pool configuration creates a pool of virtual machines 622A-622N each of which are configured with a particular memory size and operating system that run each instance of the docker image in parallel. The docker image contains the pre-processing script, libraries, tools, dependencies and other files needed to run each instance of a pre-processing job. (Collectively, block 706).

In one aspect, the fine-tuning dataset consists of a number of JSON-lines text files. Each line of the JSON-lines text file is a JSON string having a source and/or target. Each line can be processed in parallel with the other lines in the pool of virtual machines 622. The pre-processing engine 620 initiates each of the virtual machines 622A-622N to execute each instance of the pre-processing script. (Collectively, block 708).

The pre-processing jobs are monitored and the progress of each job which is reported in the status database 618 (block 710). When all jobs are finished, the output 616 or fine-tuned dataset is stored for future use (block 712).

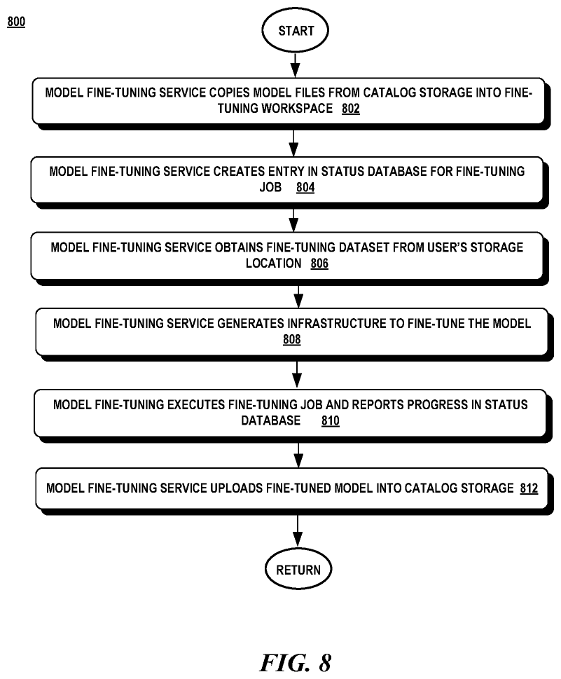

Turning to FIGS. 6 and 8, there is shown an exemplary method 800 to deploy the fine-tuned model and components used therein. The model fine-tuning service copies the model files from the catalog storage to the fine-tuning workspace (block 802). These model files include a fine-tuning script, an environment definition, the model files, and any packages that is needed to execute the fine-tuning process. The environment definition file contains a list of packages that is needed to execute the fine-tuning script (block 802).

The fine-tuning engine generates an entry for the fine-tuning job in the status database (block 804). The fine-tuning engine updates the status database with the progress of the fine-tuning job during periodic intervals in order to respond to the user's status queries (block 804). The fine-tuning engine copies the fine-tuning dataset from the user's storage account into the fine-tuning workspace (block 806).

The fine-tuning engine builds an infrastructure to fine-tune the model. The infrastructure includes the number of virtual machines, the size of the virtual machines, the operating system of the virtual machines and the preinstalled tools and packages of the virtual machines. In one aspect, the infrastructure is based off the machine configuration used to pre-train the model. (Collectively, block 808).

The fine-tuning engine then configures a fine-tuning job for the task using the infrastructure to execute the fine-tuning script. The fine-tuning script contains the instructions used to apply the input embeddings to the pre-trained model. (Collectively, block 810).

Neural transformer models are fine-tuned iteratively, making multiple passes over the fine-tuning dataset before converging to a minimum. An epoch represents the entire fine-tuning dataset passed forwards and backwards through the neural transformer block once. Since the fine-tuning dataset may be very large, it is partitioned into smaller batches. The fine-tuning is iterative and the entire dataset is passed through the neural transformer in multiple iterations. Each fine-tuning iteration includes forward propagation, loss calculation, backpropagation steps followed by updating the weights. The fine-tuning dataset is partitioned into batches with each batch of sequences running through the fine-tuning job. (Collectively, block 810).

At the completion of the fine-tuning job, the new model contains updated embeddings for the user's task and updated weights and biases. The new model is uploaded to the catalog storage. (Collectively, block 812).

Automated Deployment

Attention now turns to a discussion of the method and components used in the automated deployment 900. Automated deployment refers to the configuration of the infrastructure to run the model on a virtual machine and getting the model operational automatically without the user specifying the resources needed to deploy the model. When the model is successfully deployed, the user is given a model endpoint to use to run the fine-tuned model.

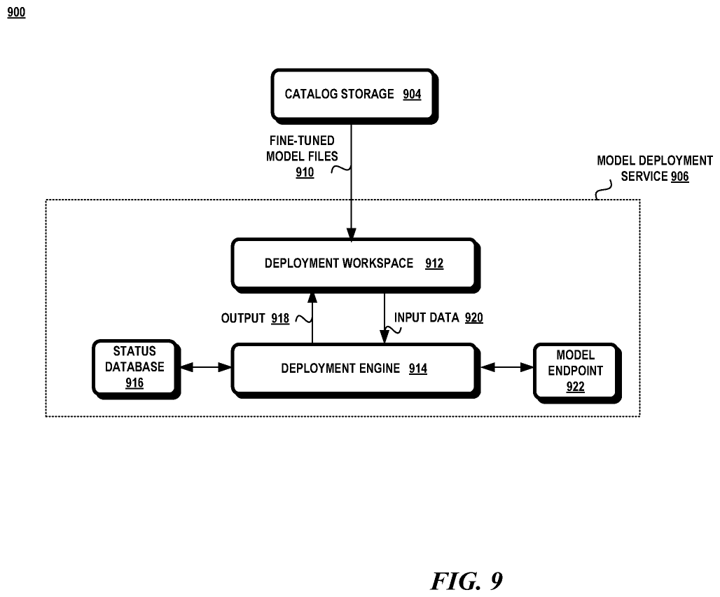

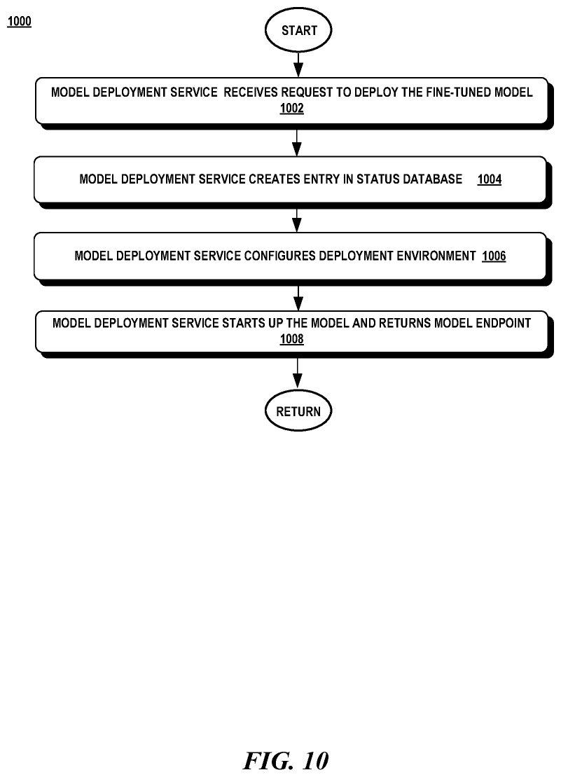

Turning to FIGS. 9 and 10, there is shown exemplary components 900 and method 1000 of the model deployment service that facilitates the automated deployment. The model deployment service 906 includes a deployment workplace 912 that includes a local storage area for the data needed to deploy the fine-tuned model. The model deployment service 906 includes a deployment engine that configures the infrastructure needed to deploy the fine-tuned model without user input.

The model deployment service 906 receives a request to deploy the fine-tuned model. An exemplary request is made using the deploy_model API as follows:

curl -X POST -H “Content-Type: application/j son” -data “@deploy.json” https://deepdev.azurewebsites.net/api/deploy_model, where the json file contains the following data:

```
{
  “name”: “newdecoder”
  “version”: “java”
  }
```

(Collectively, block 1002).

The deployment engine 914 creates an entry in the status database 916 for the task. The deployment engine 914 updates the status of the task in the database 916 at periodic intervals in order to respond to requests for a deployment status. (Collectively, block 1004).

The deployment engine 914 copies the model files from the catalog storage 904 to the deployment workspace 912 which also include a deployment script and a deployment environment definition. (Collectively, block 1006).

The deployment engine 914 creates a deployment configuration The deployment configuration includes the number of the virtual machines, the size of the virtual machines, the virtual machine scaling rules, the operating system of the virtual machines, the preinstalled tools and package on the virtual machines, etc. (Collectively, block 1008)

The deployment engine 914 initiates the deployment job with the customized infrastructure. The deployment engine 914 monitors the progress of the job and updates the status database with status updates. (Collectively, block 1010).

Upon successful completion of the model deployment, the deployment engine returns a model endpoint back to the user (block 1012).

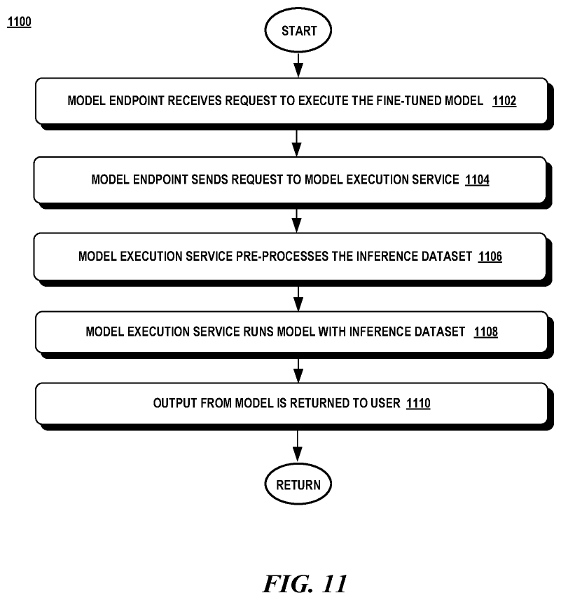

FIG. 11 shows an exemplary method 1100 for executing the fine-tuned model with the user's inference dataset. Turning to FIG. 11, the model endpoint receives a request to execute the model (block 1102). The model endpoint sends the request to the model execution service (block 1104). The model execution service pre-processes the inference dataset in a similar manner as noted above (block 1106) and runs the model with the processed inference dataset (block 1108). Upon completion of the model's run, the output is returned to the user (block 1110).

Exemplary Operating Environment

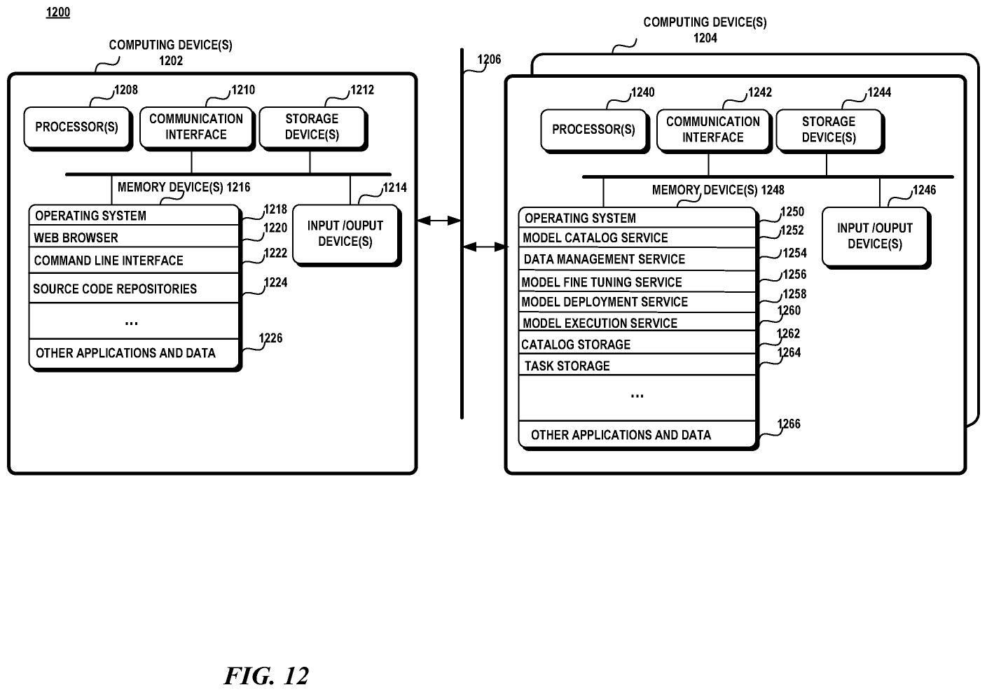

Attention now turns to a discussion of an exemplary operating environment 1200. FIG. 12 illustrates an exemplary operating environment 1200 in which computing devices of various users 1202 interacts with a cloud platform having several computing devices 1204, through a network 1206. In one aspect, computing device 1202 may be associated with a user that interfaces with a cloud platform having various web service consisting of one or more computing devices 1204. However, it should be noted that the aspects disclosed herein is not constrained to any particular configuration of devices. It should be noted that the operating environment is not limited to any particular configuration and other configurations are possible.

The computing devices 1202, 1204 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 800 may be configured in a network environment, a distributed environment, a multi-processor environment, or a stand-alone computing device having access to remote or local storage devices.

The computing devices 1202, 1204 may include one or more processors 1208, 1240, one or more communication interfaces 1210, 1242, one or more storage devices 1212, 1244, one or more input/output devices 1214, 1246, and one or more memory devices 1216, 1248. A processor 1208, 1240 may be any commercially available or customized processor and may include dual microprocessors and multi-processor architectures. A communication interface 1210, 1242 facilitates wired or wireless communications between the computing device 1202, 1204 and other devices. A storage device 1212, 1244 may be computer-readable medium that does not contain propagating signals, such as modulated data signals transmitted through a carrier wave. Examples of a storage device 1212, 1244 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1212, 1244 in the computing devices 1202, 1204. The input/output devices 1214, 1246 may include a keyboard, mouse, pen, voice input device, touch input device, display, speakers, printers, etc., and any combination thereof.

A memory device or memory 1216, 1248 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory 1216, 1248 may also include one or more external storage devices or remotely located storage devices that do not pertain to propagated signals, such as modulated data signals transmitted through a carrier wave.

The memory device 1248 of computing device 1204 may contain instructions, components, and data. A component is a software program that performs a specific function and is otherwise known as a module, program, component, engine, and/or application. The memory device 1248 may include an operating system 1250, a model catalog service 1252, a data management service 1254, a model fine-tuning service 1256, a model deployment service 1258, a catalog storage 1260, user storage accounts 1262, a task storage 1264, and other applications and data 1266.

The memory device 1216 of the computing devices 1202 may include an operating system 1218, a web browser 1220, a command line interface 1222, source code repositories 1224, and other applications and data 1226.

The computing devices 1202, 1204 may be communicatively coupled via a network 1206. The network 1206 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 1206 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

A system is disclosed comprising one or more processors and a memory that stores one or more programs that are configured to be executed by the one or more processors. The one or more programs including instructions to perform acts that: provide a plurality of pre-trained deep learning models, wherein a pre-trained deep learning model is pre-trained on unsupervised training data of source code and natural language text, wherein a pre-trained deep learning model is tailored for a particular software engineering task; receive a request to fine-tune a select one of the plurality of pre-trained deep learning models on a custom dataset; build an automated fine-tuning infrastructure to fine-tune the select one of the plurality of pre-trained deep learning models with the custom dataset without user configuration input, wherein the automated fine-tuning infrastructure restricts access to parameters of the select one of the plurality of pre-trained deep learning models; and fine-tune the select one of the plurality of pre-trained deep learning models with the custom dataset using the automated fine-tuning infrastructure to generate a custom version of the select one of the plurality of pre-trained deep learning models.

In one aspect, the one or more programs include instructions to perform acts that build an automated deployment infrastructure to deploy the custom version of the select one of the plurality of pre-trained deep learning models without user configuration input, wherein the automated deployment infrastructure restricts access to parameters of the custom version of the select one of the plurality of pre-trained deep learning models.

In an aspect, the one or more programs include further instructions that run the custom version of the select one of the plurality of the pre-trained deep learning models using the automated deployment infrastructure with custom inference data. In an aspect, each of the pre-trained deep learning models includes an environment definition file, a fine-tuning script, a deployment script, and a tokenizer. In an aspect, the plurality of pre-trained deep learning models includes an encoder neural transformer with attention, a decoder neural transformer with attention, and/or encoder-decoder neural transformer with attention.

In an aspect, the automated fine-tuning infrastructure includes one or more virtual machines, a virtual operating system, and tools and/or packages for the one or more virtual machines. In an aspect, the automated fine-tuning infrastructure includes a pre-processing engine to process the custom dataset for the select one of the pre-trained deep learning models. In an aspect, the parameters include weights, biases, and/or embeddings.

A method is disclosed that is performed on a computing device having a processor and a memory. The method comprises: offering a plurality of pre-trained deep learning models to a user for reuse, wherein the plurality of pre-trained deep learning models is pre-trained with unsupervised training datasets of source code and natural language text for software engineering tasks; providing a plurality of model files for each of the plurality of pre-trained deep learning models, wherein the plurality of model files is isolated from the user, wherein a first subset of the plurality of model files is for fine-tuning and a second subset of the plurality of model files is for deployment; receiving a request to reuse a select one of the plurality of pre-trained deep learning models; building an automated fine-tuning infrastructure to generate a custom version of a select one of the pre-trained deep learning models without user configuration input, wherein the automated fine-tuning infrastructure is built using the first subset of the model files; and building an automated deployment infrastructure to deploy the custom version of the select one of the pre-trained deep learning models without user configuration input, wherein the automated deployment infrastructure is built using the second subset of the model files.

In an aspect, the method further comprises fine-tuning the select one of the pre-trained deep learning models using the automated fine-tuning infrastructure with a custom tuning dataset to produce the custom version of the select one of the pre-trained deep learning models.

In an aspect, the method further comprises upon successful completion of fine-tuning the select one of the pre-trained deep learning models, deploying the custom version of the select one of the pre-trained deep learning models in the automated deployment infrastructure.

In an aspect, the method further comprises generating a model endpoint to receive requests to execute the custom version of the select one of the pre-trained deep learning models with an inference dataset.

In an aspect, the plurality of deep learning models includes an encoder neural transformer model with attention, decoder neural transformer model, and an encoder-decoder neural transformer model with attention.

A cloud platform is disclosed comprising: a plurality of services, wherein each of the plurality of services includes a processor and a memory, wherein the plurality of services includes a model catalog service, a data management service, a model fine-tuning service, and a model deployment service, wherein the processor of the model catalog service is configured to perform acts that: provide a plurality of pre-trained deep learning models for reuse, each of the plurality of pre-trained deep learning models configured for a particular software engineering task; wherein the processor of the data management service is configured to perform acts that: obtain a request for reuse of a select one of the plurality of pre-trained deep learning models; wherein the processor of the model fine-tuning service is configured to perform acts that: build a fine-tuning infrastructure to fine-tune the select one of the plurality of pre-trained deep learning models with a custom tuning dataset without user configuration input, wherein the fine-tuning infrastructure restricts access to parameters of the select one of the plurality of deep learning models and the fine-tuned model; and wherein the processor of the model deployment service is configured to perform acts that: build a deployment infrastructure to deploy the fine-tuned model without user configuration input, wherein the deployment infrastructure restricts access to parameters of the fine-tuned model.

In an aspect, each of the plurality of pre-trained deep learning models includes a fine-tuning script, a deployment script, a tokenizer and an environment definition file. In an aspect, the plurality of pre-trained deep learning models is configured for a software classification task, a software translation task, and an autoregressive software task. In an aspect, the plurality of pre-trained deep learning models includes an encoder neural transformer model with attention, a decoder neural transformer model with attention, and an encoder-decoder neural transformer model with attention.

In an aspect, the processor of the model deployment service is configured to perform acts that: run the deployment infrastructure to deploy the fine-tuned model and generate a model endpoint for the fine-tuned model. In an aspect, the plurality of services includes a model execution service, having a processor and a memory, wherein the processor of the execution service is configured to execute the deployed model with an inference dataset. In an aspect, the processor of the model execution service is configured to: pre-process the inference dataset into a form used by the deployed model; and execute the deployed model with the pre-processed inference dataset.

What is claimed:

1. A system comprising:
one or more processors; and
a memory that stores one or more programs that are configured to be executed by the one or more processors, the one or more programs including instructions to perform acts that:
provide a plurality of pre-trained deep learning models, wherein a pre-trained deep learning model is pre-trained on unsupervised training data of source code and natural language text, wherein a pre-trained deep learning model is tailored for a particular software engineering task;
receive a request to fine-tune a select one of the plurality of pre-trained deep learning models on a custom dataset;
build an automated fine-tuning infrastructure to fine-tune the select one of the plurality of pre-trained deep learning models with the custom dataset without user configuration input, wherein the automated fine-tuning infrastructure restricts access to parameters of the select one of the plurality of pre-trained deep learning models; and
fine-tune the select one of the plurality of pre-trained deep learning models with the custom dataset using the automated fine-tuning infrastructure to generate a custom version of the select one of the plurality of pre-trained deep learning models.

2. The system of claim 1, wherein the one or more programs include instructions to perform acts that:
build an automated deployment infrastructure to deploy the custom version of the select one of the plurality of pre-trained deep learning models without user configuration input, wherein the automated deployment infrastructure restricts access to parameters of the custom version of the select one of the plurality of pre-trained deep learning models.

3. The system of claim 2, wherein the one or more programs include further instructions that:
run the custom version of the select one of the plurality of the pre-trained deep learning models using the automated deployment infrastructure with custom inference data.

4. The system of claim 1, wherein each of the pre-trained deep learning models includes an environment definition file, a fine-tuning script, a deployment script, and a tokenizer.

5. The system of claim 1, wherein the plurality of pre-trained deep learning models includes an encoder neural transformer with attention, a decoder neural transformer with attention, and/or encoder-decoder neural transformer with attention.

6. The system of claim 1, wherein the automated fine-tuning infrastructure includes one or more virtual machines, a virtual operating system, and tools and/or packages for the one or more virtual machines.

7. The system of claim 1, wherein the automated fine-tuning infrastructure includes a pre-processing engine to process the custom dataset for the select one of the pre-trained deep learning models.

8. The system of claim 1, wherein the parameters include weights, biases, and/or embeddings.

9. A method performed on a computing device having a processor and a memory, the method comprising:
offering a plurality of pre-trained deep learning models to a user for reuse, wherein the plurality of pre-trained deep learning models is pre-trained with unsupervised training datasets of source code and natural language text for software engineering tasks;
providing a plurality of model files for each of the plurality of pre-trained deep learning models, wherein the plurality of model files is isolated from the user, wherein a first subset of the plurality of model files is for fine-tuning and a second subset of the plurality of model files is for deployment;
receiving a request to reuse a select one of the plurality of pre-trained deep learning models;
building an automated fine-tuning infrastructure to generate a custom version of a select one of the pre-trained deep learning models without user configuration input, wherein the automated fine-tuning infrastructure is built using the first subset of the model files; and
building an automated deployment infrastructure to deploy the custom version of the select one of the pre-trained deep learning models without user configuration input, wherein the automated deployment infrastructure is built using the second subset of the model files.

10. The method of claim 9, further comprising:
fine-tuning the select one of the pre-trained deep learning models using the automated fine-tuning infrastructure with a custom tuning dataset to produce the custom version of the select one of the pre-trained deep learning models.

11. The method of claim 10, further comprising:
upon successful completion of fine-tuning the select one of the pre-trained deep learning models, deploying the custom version of the select one of the pre-trained deep learning models in the automated deployment infrastructure.

12. The method of claim 11, further comprising:
generating a model endpoint to receive requests to execute the custom version of the select one of the pre-trained deep learning models with an inference dataset.

13. The method of claim 9, wherein the plurality of deep learning models includes an encoder neural transformer model with attention, decoder neural transformer model, and an encoder-decoder neural transformer model with attention.

14. A cloud platform, comprising:
a plurality of services, wherein each of the plurality of services includes a processor and a memory, wherein the plurality of services includes a model catalog service, a data management service, a model fine-tuning service, and a model deployment service,
wherein the processor of the model catalog service is configured to perform acts that:
provide a plurality of pre-trained deep learning models for reuse, each of the plurality of pre-trained deep learning models configured for a particular software engineering task;
wherein the processor of the data management service is configured to perform acts that:
obtain a request for reuse of a select one of the plurality of pre-trained deep learning models;
wherein the processor of the model fine-tuning service is configured to perform acts that:
build a fine-tuning infrastructure to fine-tune the select one of the plurality of pre-trained deep learning models with a custom tuning dataset without user configuration input, wherein the fine-tuning infrastructure restricts access to parameters of the select one of the plurality of deep learning models and the fine-tuned model; and
wherein the processor of the model deployment service is configured to perform acts that:
build a deployment infrastructure to deploy the fine-tuned model without user configuration input, wherein the deployment infrastructure restricts access to parameters of the fine-tuned model.

15. The cloud platform of claim 14, wherein each of the plurality of pre-trained deep learning models includes a fine-tuning script, a deployment script, a tokenizer and an environment definition file.

16. The cloud platform of claim 14, wherein the plurality of pre-trained deep learning models are configured for a software classification task, a software translation task, and an autoregressive software task.

17. The cloud platform of claim 14, wherein the plurality of pre-trained deep learning models includes an encoder neural transformer model with attention, a decoder neural transformer model with attention, and an encoder-decoder neural transformer model with attention.

18. The cloud platform of claim 14, wherein the processor of the model deployment service is configured to perform acts that:
run the deployment infrastructure to deploy the fine-tuned model and generate a model endpoint for the fine-tuned model.

19. The cloud platform of claim 14, wherein the plurality of services includes a model execution service, having a processor and a memory, wherein the processor of the execution service is configured to execute the deployed model with an inference dataset.

20. The cloud platform of claim 19, wherein the processor of the model execution service is configured to:
pre-process the inference dataset into a form used by the deployed model; and
execute the deployed model with the pre-processed inference dataset.
